(19) United States
(12) Patent Application Publication
(10) Pub. No.: US 2016/0041344 A1
(43) Pub. Date: Feb. 11, 2016

(54) Multi-Fiber Optical Connector with Integrated Dust Shield

(71) Applicant: John G. Wasserbauer, Casto Valley, CA (US)

(72) Inventor: John Wasserbauer, Castro Valley, CA (US)

(21) Appl. No.: 14/455,954

(22) Filed: Aug. 11, 2014

(51) Int. Cl. G02B 6/38; G02B 6/26; G02B 6/32

(52) U.S. Cl. CPC G02B 6/3849; G02B 6/3825; G02B 6/3846; G02B 6/32; G02B 6/264; G02B 6/3883

(57) ABSTRACT

The present invention is a multi-fiber optical connector apparatus and method of fabrication. The fibers are precisely aligned by means of holes etched or machined into a substrate. The fibers are centered in the holes by means of a plurality of flexible fingers at the exit end of the holes. Alignment between fiber arrays is achieved by means of guide pins inserted into the substrate and engaging with matching holes in the mating connector. The fibers may be terminated at an angle and an anti-reflection coating applied to the termination in order to reduce back reflection. An expanded beam version of the connector includes a beam expansion section and micro lens array attached to the fiber array. An integrated, self-opening and sealing dust cap is used to prevent contamination of the multi-fiber ferrule.

### BACKGROUND OF THE INVENTION

1. Field of the Invention

The present invention relates to designs, systems and methods of a multi-fiber optical connector.

2. Background of the Invention

The ever-increasing demand for greater bandwidth is driving the need for higher density optical fiber connections at a single point. To meet this demand multi-fiber cables are being developed to service the various fiber terminations, including “fiber-to-the-curb” (FTTC), “fiber-to-the-business” (FTTB), “fiber-to-the-premises” (FTTP), and “fiber-to-the-home” (FTTH), generically referred to as “FTTx.” What is needed is a low-cost, high-performance, reliable and scalable approach to multi-fiber optical connectors.

A variety of fiber optic connectors are used to terminate fiber optic cables. Single fiber cables are terminated with single fiber connectors, dual fiber cables are terminated with duplex connectors, and multi-fiber cables, typically ribbon-fiber based, are terminated with more complex connector assemblies. Each type of connector uses a specialized ferrule and adapter pair to receive and align the connectors. In the case of multi-fiber ferrules, the connector housing and adapter serve to coarsely align the fibers, while fine alignment is achieved via guide pins and holes formed directly in the ferrule end face. Typically, connectors are designed in pairs where each pair comprises a male and female version, with the guide pins and holes residing in the male and female ferrules, respectively. The adapters and housings are toleranced such that some lateral and rotational movement of the ferrule is allowed during mating. The ferrules are typically exposed within the housing and cleaning is recommended or required prior to mating within an adapter. A dust cap is generally used to prevent contamination while the connector is unconnected.

Several standardized and de-facto standard multi-fiber connector technologies have been developed, including, but not limited to, FC, SC, LC, MT-RJ, and MPO connectors. The size and shape of each of these connectors and the corresponding adapters vary significantly. Ferrule profiles may be cylindrical, rectangular or square in shape, even when the connector housing has a different profile, e.g. round. To date, however, none of the current configurations provides for sufficiently high fiber density, while at the same time meeting the absolute performance requirements and relative channel-to-channel uniformity of today's demanding applications. The reason for this lies in the fabrication process of the multi-fiber connector. Generally, the fibers are inserted into the ferrules and a polishing operation is used to render the fiber facets coplanar with the ferrule face. Polishing also serves to give the fiber facets sufficient optical quality so as to minimize insertion loss in the optical channel. However, some rounding of the ferrule face, usually near the edge, invariably occurs during this operation, resulting in a gap between fibers during mating. As a consequence, the number of rows of fibers that may be combined in a ferrule is typically limited to no more than two. There is, as yet, an unmet need for a connector technology that can accommodate a large number of fibers simultaneously, without these drawbacks.

In addition to the lack of sufficient fiber density, poor uniformity and low performance, exposure to adverse environmental conditions is also a significant issue. Dust, dirt and other contamination adversely affect the insertion loss, back reflection, durability and reliability of all optical fiber connectors, a problem which is exacerbated in connectors with larger numbers of fibers. A multi-fiber connector is more easily contaminated, more difficult to clean, and more easily damaged than a single fiber connector. Typically, a removable dust cap is used to keep connectors clean between matings. However, removal of the dust cap occurs well away from the adapter and usually well before insertion, leaving ample opportunity for a contamination event. There remains an unresolved need for a more robust solution to the contamination problem.

### SUMMARY OF INVENTION

The present invention is a multi-fiber optical connector apparatus and method of fabrication. The invention provides for a means of precise alignment between fibers in a fiber array. Specifically, holes are etched or micro-machined into a template using lithographic techniques as are known in the art. The exit end of the hole has a diameter slightly less than that of the fibers. Additional etching is used to segment said opening to form flexible fingers which engage the outer surface of each fiber, gently pushing it toward the center of the hole. Fibers in an array may be substantially coplanar with the substrate or may protrude out of the plane of the template. Fiber facets may be terminated at zero degrees or at an angle, may be flat or rounded, and may be anti-reflection (AR) coated in order to reduce back reflection and improve scratch resistance. Fiber arrays thus formed may be aligned to one another via guide pins inserted into lithographically defined holes in each substrate or in a suitably precise substrate holder. Additional fine alignment may be provided by angled alignment fibers in the array.

A non-contact, expanded beam version of the connector includes a lens array attached to the bare fiber array by means of an adhesive, preferably inorganic, such as sodium silicate or water glass. The adhesive provides an index match between the fiber array and expansion plate so as to minimize back reflection. Advantageously, an inorganic adhesive will not deteriorate under high power density infrared irradiation. Additional suppression of back reflection may be obtained by angling the fiber facets, or the mating surface of the glass, or both. The lens array includes a beam expansion section and may be AR coated in order to reduce back reflection and improve scratch resistance. The lens array may be of the collimating or focusing type. Expanded beam arrays may be aligned to each other by means of guide pins in the ferrule, or by ferrule/adapter mating, or both. Physical separation is achieved by means of a standoff formed in the adapter or on the surface of the ferrule.

An integrated, self-opening and sealing dust cap is used to prevent contamination of the multi-fiber ferrule, thereby increasing the performance, repeatability and lifetime of the connector.

### BRIEF DESCRIPTION OF THE DRAWINGS

In the drawings, like numerals describe like components throughout the several views:

FIG. 1. Exploded, perspective view of multi-fiber ferrule.

FIG. 2. Top view (a) and cross section (b) of a multi-fiber ferrule.

FIG. 3. Top view (a) and cross sections (b), (c), (d) and (e) of a multi-chip template for an 8×8 fiber array with extra holes for chip and mating alignment.

FIG. 4. Close-up, perspective view of a fiber hole with alignment fingers and inserted fiber.

FIG. 5. Top view (a) and cross section (b) of fiber hole with alignment fingers and inserted fiber.

FIG. 6. Exploded, perspective view of expanded beam ferrule.

FIG. 7. Top view (a) and cross sections (b), (c) and (d) of expanded beam ferrule.

FIG. 8. Perspective view of (a) closed and (b) open clam shell style integrated dust cap.

FIG. 9. Perspective view of (a) closed and (b) open garage door style integrated dust cap.

FIG. 10. Perspective view of (a) closed and (b) open awning style integrated dust cap.

### DETAILED DESCRIPTION OF THE EMBODIMENTS

In the following detailed description, reference is made to the accompanying drawings, which form a part hereof, and in which is shown by way of illustration specific embodiments in which the invention can be practiced. These embodiments are described in sufficient detail to enable those skilled in the art to practice the invention, and it is to be understood that other embodiments can be utilized and that structural changes can be made without departing from the spirit and scope of the present invention. Therefore, the following detailed description is not to be taken in a limiting sense, and the scope of the present invention is defined by the appended claims.

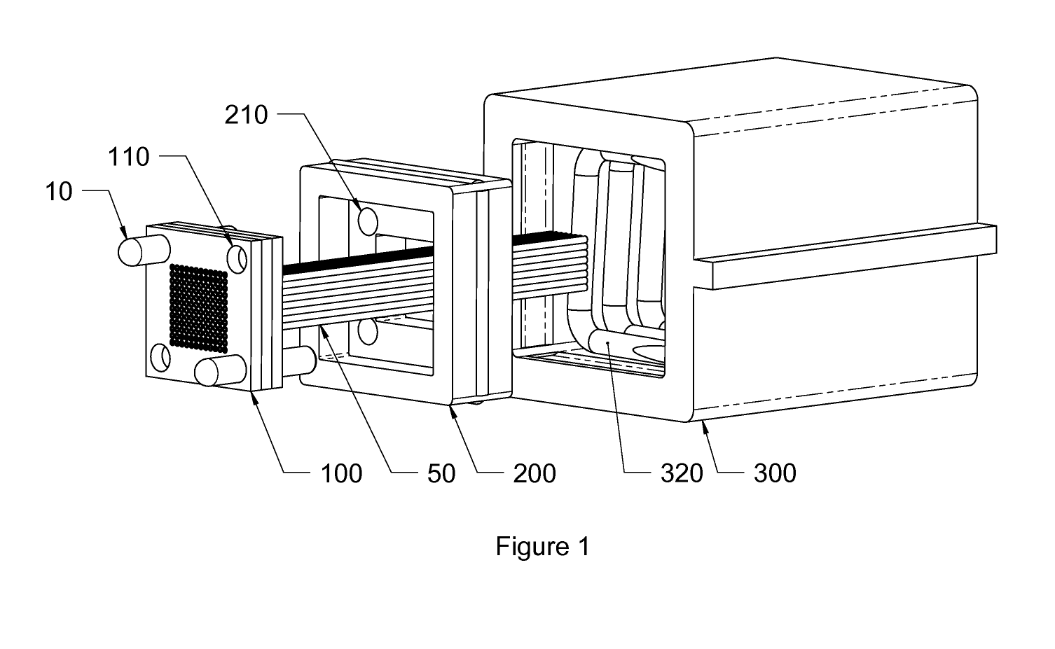

FIG. 1 presents an exploded, perspective view of the multi-fiber ferrule. The ferrule comprises three major parts: a template 100 for accurate registration of the fibers, a template holder 200 for robust handling and precision movement of the template, and a ferrule housing 300 for providing a spring force and interfacing with a connector housing (not shown). The three elements are aligned, or aligned and joined, by means of one or more guide pins 10 and matching guide pin holes 110, 210. In an alternative embodiment, the guide pin holes are located in the template holder 200. In this case the template must be aligned to the template holder by other means, such as recessed edges, corners, protrusions or other mechanical datum. The fiber array 50 is inserted into the back side of the template. A portion of the guide pins protrude from the front of the template and serve to align opposing fiber arrays during connector-to-connector mating.

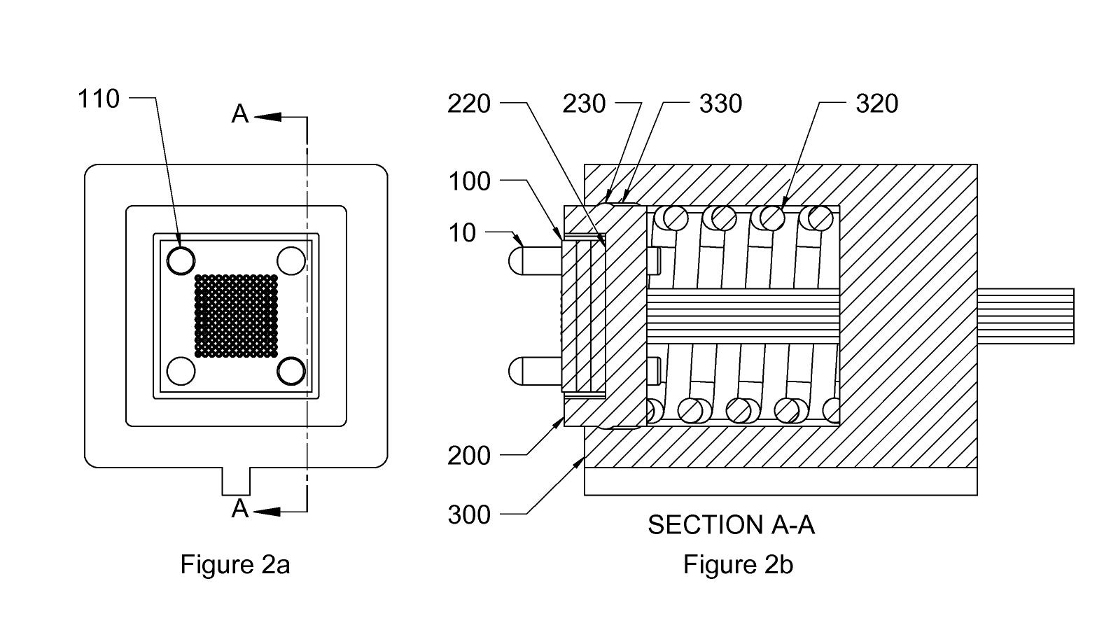

FIG. 2 gives a top view and cross section of the multi-fiber connector. Referring to FIG. 2b, the base of the template, when assembled, is fixed to the inner shelf 220 of the template holder such that the top surface of the template 100 protrudes slightly above the template holder 200. When the fibers protrude from the template surface, this ensures physical contact between the fibers during connector mating. The holder sits snugly inside the ferrule housing 300. Coarse alignment may be achieved through contact between the ferrule housing and a pluggable socket or adapter. Alternatively coarse alignment may be achieved via contact between the connector housing and adapter. In either case it is important that the guide pins make contact only with the guide pin holes and not with the surface of the opposing template. Fine alignment is achieved via the guide pin 10/hole 110 combination. In the present embodiment, the holder floats with respect to the ferrule housing such that, upon mating with an opposing connector, the template faces become parallel and all fibers make physical contact with opposing fibers. In the present embodiment this is achieved by means of a rib 230 and trench 330 combination in the holder and ferrule, respectively. The ferrule housing engages the rear of the holder by means of a spring 320 which is compressed within the housing and precisely determines the applied spring force. The holder is limited in its forward travel to a point that is substantially planar with the front of the ferrule. Thus, a small amount of translation along the z-axis and rotation about the x and y-axes are possible for the fiber array.

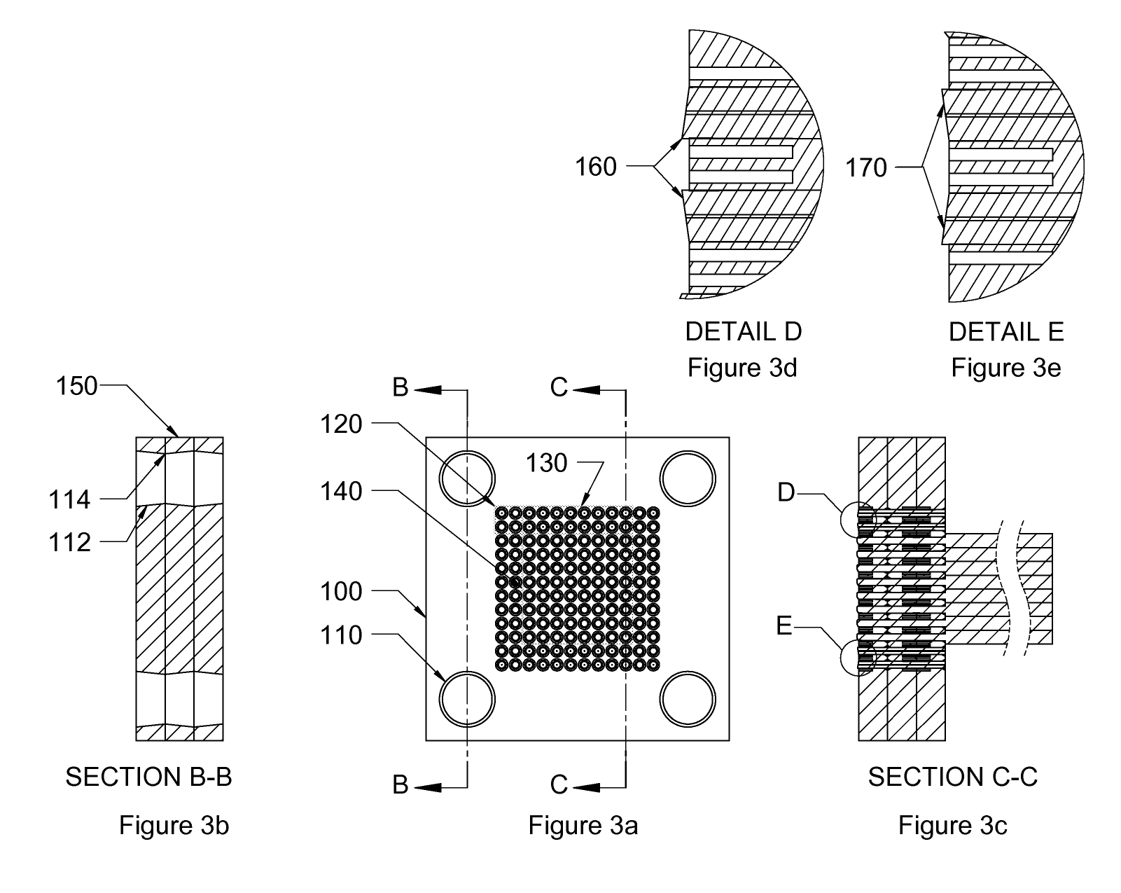

In an exemplary embodiment, illustrated in FIG. 3, a substrate is formed into a plurality of chips 150 and then aligned and bonded together to create a mechanically robust template 100 for the fiber array. The template comprises a three chip stack for an 8×8 fiber array, shown in cross section in FIG. 3b, in which additional fiber holes have been etched. Referring to FIG. 3a, the holes are of three types: chip-to-chip alignment holes 120, connector-to-connector fine alignment holes 130, and array holes 140 for the signal-carrying fibers. In this way at least two axial points of contact exist for each fiber and pin. The chips are aligned by inserting fiber stubs in the chip-to-chip alignment holes 120 located in the corners of the array. The chip-to-chip alignment fibers are secured with adhesive. In addition to the fiber holes, larger guide pin holes 110 are etched into the chip stack in order to provide for connector-level coarse alignment. The guide pin holes have a reverse taper 112 (i.e. the diameter shrinks with depth) so as to allow the guide pins to be inserted more easily after fiber insertion and processing. The point of contact 114 between the guide pin and hole is at the narrow end of the taper. Referring again to FIG. 3b, the center chip 150 of the stack may be reversed in orientation in order to provide a more robust point of contact 114 for the guide pins. The guide pins are secured in the holes with adhesive. In an exemplary embodiment, the guide pin holes provide an interference fit to the guide pins of the mating connector such that multiple insertions can be made without enlarging or damaging the holes. In an alternative embodiment, a single chip is used and matching fiber and pin bores are present in the template holder. In this design at least two axial points of contact are retained, but fewer chips are used. However, this approach does require a means for precise alignment between the template and template holder, which can be realized by a variety of mechanical datum, such as edges, corners, ribs or other protrusions.

In an exemplary embodiment, additional alignment accuracy is achieved by orienting the fibers 90 or 180 degrees to one another, as illustrated in FIG. 3c. Two approaches can be taken. First, the angle-polished ribbon fibers can be inserted with alternating orientations in the signal carrying fiber array 140. When mated, the fibers form a triangle-in-groove arrangement, as shown in the detail views of FIG. 3d and FIG. 3e, which provides a centering force along one axis. Second, additional, alignment-only fiber arrays 130 may be mounted along the edges of the hole array to provide a centering force in either the x or y direction, or both. Both approaches may be used simultaneously. Note that if two-axis alignment is used, a complementary connector cannot be generated from a 180-degree rotation operation, as is required for unisex mating connectors. In this case unique male and female connectors are required. Male 160 and female 170 alignment fiber configurations are shown in FIGS. 3(d) and (e). Note that in FIG. 3, only single-axis alignment-only fiber arrays are used with a uniformly oriented 8×8 signal array, thereby creating a unisex connector.

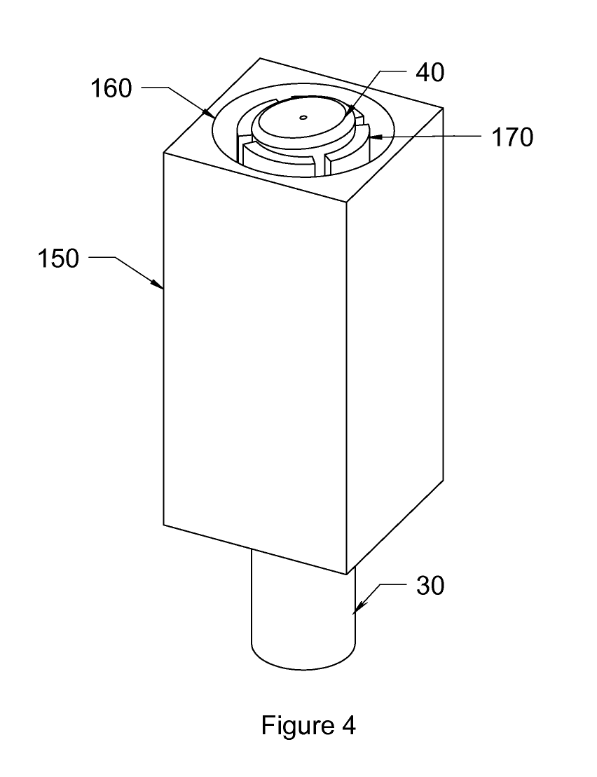

In establishing a connection between optical fibers the three most important elements are insertion loss, back reflection, and repeatability. For applications in uncontrolled or harsh environments ruggedness is also a factor. To minimize insertion loss and maximize repeatability, the core-to-core fiber alignment must be maximized. The present invention provides for ultra-precise alignment by means of lithographically defined holes into which the fibers are inserted to form an array. Holes are fabricated in the substrate via wet chemical etching, dry etching, laser drilling or other micromachining technique. Due to lithography and/or etch process non-uniformity, the diameter of a hole can change slightly depending on its location on the substrate. Variations in hole diameter can lead to variations in the fiber-to-fiber pitch, which, in turn, can lead to a lateral misalignment of up to several pm during connector mating. In contrast to the hole diameter uniformity, the hole-to-hole registration, or pitch, is much more precise. This is because state-of-the-art mask fabrication processes are accurate to within a few nanometers and the masks themselves do not change significantly during the lithography process. As a result, the center-to-center pitch of the holes retains this precision even when the hole diameter varies significantly. In the present invention this fact is used advantageously to create a high precision array by means of flexible fingers located at the exit end of the holes which guide the fibers toward the hole center. FIG. 4 illustrates this concept by way of a substrate (chip) 150 with a through hole 160 into which is inserted an optical fiber 30 from the bottom. As the fiber exits the hole at the top, segmented fingers 170 engage the outside of the fiber thereby centering it in the hole. In this illustration the tip of the fiber is angled and rounded 40.

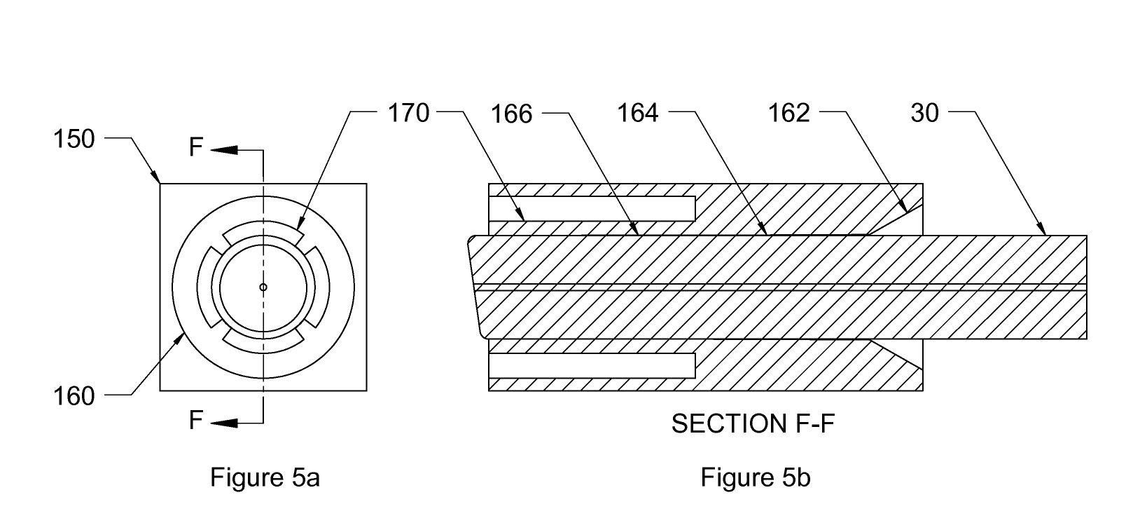

The hole 160 is designed to have a funnel shape, as depicted in FIG. 5. There are up to three distinct regions along the length of the hole, a cross section of which is displayed in FIG. 5b. At one end, a large taper 162 is created to facilitate fiber insertion. In an exemplary embodiment, this taper is fabricated by means of selective, wet chemical etching of photoimageable glass. In an alternative embodiment, this taper is fabricated by means of anisotropic, wet chemical etching of a silicon substrate. The center of the hole 164 has a diameter that is slightly larger than the outer diameter of the fiber so that the fiber passes freely through. At the exit end of the hole 166, the diameter is chosen to be slightly smaller than the outer diameter of the fiber so that the fiber engages the flexible fingers 170 as it passes through. As the fiber 30 is inserted, the fingers flex outward and exert an opposing force, thereby keeping the fiber centered in the hole. In a preferred embodiment a smooth taper is used to reduce the diameter from the entry to the exit regions of the hole, thereby ensuring smooth fiber insertion.

To minimize back reflection the fibers may be angled or AR coated, or both. In an exemplary embodiment, the fibers are inserted as one-dimensional arrays, as, for example, from fiber ribbon, such that they protrude from the surface of the template and create a fiber “forest.” A temporary matrix, such as wax, is used to pot the fiber forest. The fibers are then polished at an angle and rounded slightly to reduce the chance of breakage at sharp edges. After polishing the matrix is dissolved and the fibers are pulled back to the surface of the substrate, leaving a slight protrusion to allow for fiber-to-fiber contact during connector coupling. The fibers are fixed in place with adhesive. A fillet of adhesive around the protrusion provides additional mechanical robustness and allows the fiber array to be cleaned by wiping without snagging on the protrusion. At this point the fiber/substrate assembly is AR coated. Alternatively, the fibers may be angle cleaved or polished and AR coated prior to insertion into the substrate. Advantageously, the AR coating protects the fiber from wear during physical contact.

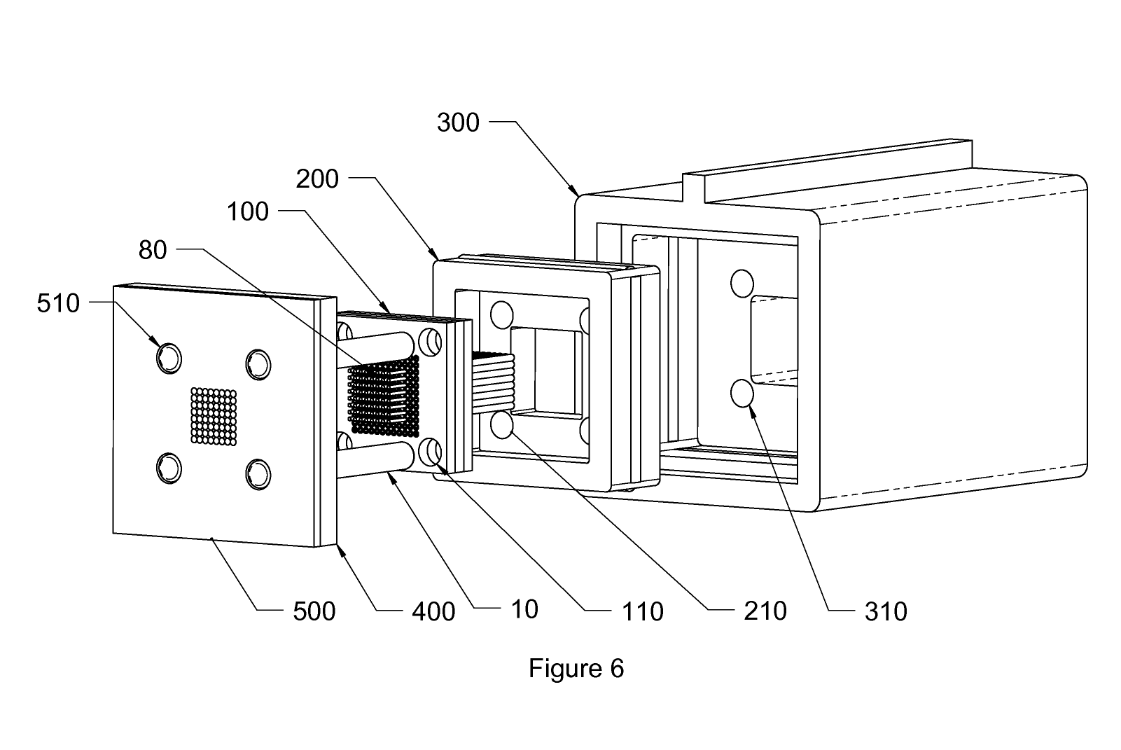

A non-contact version of this connector may be realized by adding two optical elements, as shown in FIG. 6. The first element is a beam expander 400 in the form of a glass or quartz plate, which is attached to the fiber forest 80 via an adhesive, preferably inorganic, such as sodium silicate or water glass. The second optical element that must be added is a microlens array 500 which serves to collimate or focus the expanded beam. In an exemplary embodiment, this array is made of silicon and is AR coated in order to minimize back reflection. The microlens array is placed directly on the beam expander, aligned and fixed with adhesive. The adhesive may be of the organic type, as the optical power density is sufficiently low for the expanded beam that degradation due to irradiation is not a concern. Coarse alignment of the fiber array may be achieved via guide pins 10 protruding from the template and guide pin holes 510 etched into the lens array. Alternatively, the beam expander/lens array may be integrated on a single piece of glass. At the connector level, the collimated beams pass through free space, are refocused by the lens array of the mating connector through the glass plate, and captured by the fiber cores.

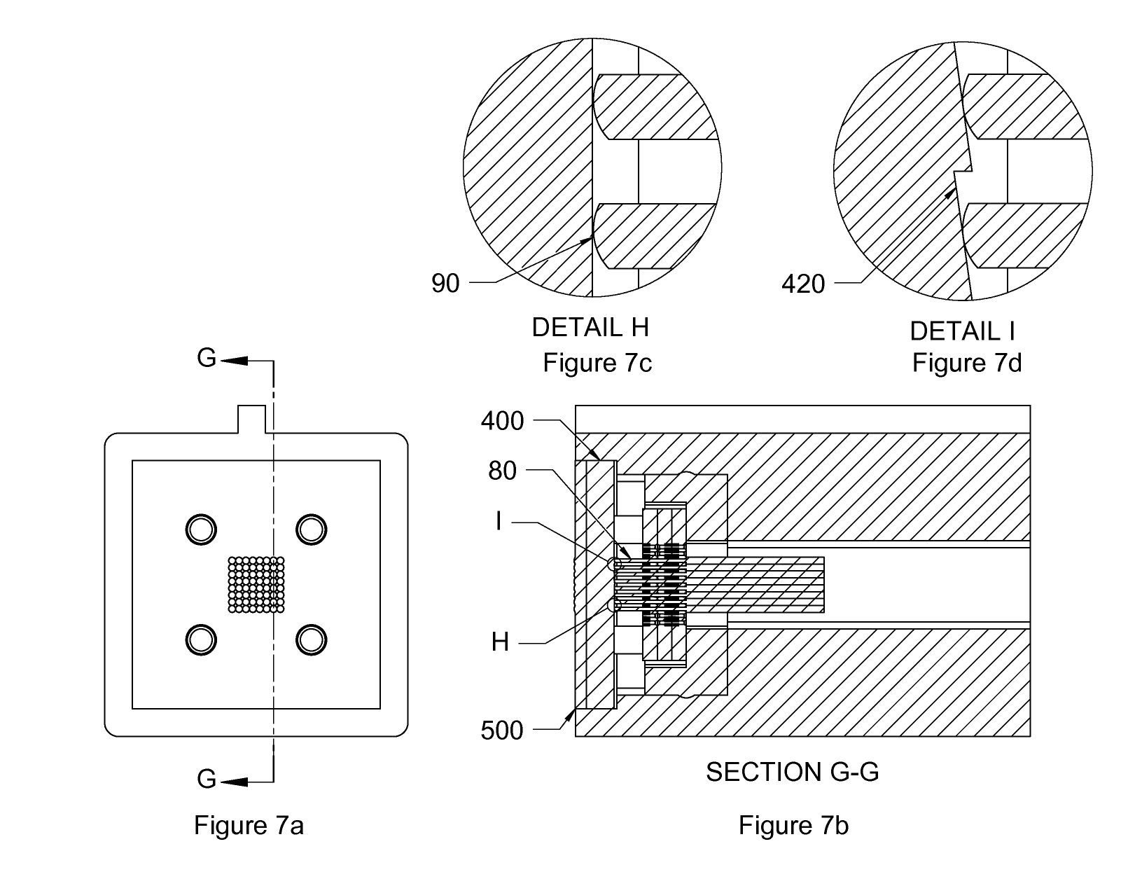

FIG. 7 gives a top view, cross section and several detailed views of the fiber forest 80/beam expander 400 interface. To minimize back reflection from the fiber/adhesive/glass plate interfaces, the adhesive must be precisely index matched or much thinner than the wavelength of light in the fiber, or both. Alternatively, the fiber can be angled such that back reflection occurs at a sufficiently high angle that it escapes the fiber core. Referring to FIG. 7c, cleaving the fiber at an angle opens a gap 90 between the fiber core and glass plate which must be bridged by the adhesive. For a cleave angle of 8° the gap is approximately 9 μm. While it is possible to bridge this gap with water glass or other adhesive, more consistent results can be obtained with a smaller gap. One way to minimize the gap is to round the angled fiber facet, as exemplified in FIG. 7c. This significantly reduces the height of the facet apex and brings the point of contact with the glass plate closer to the fiber core. Another way is to blaze a grating 420 into the fiber side of the beam expander/lens array with an angle and pitch matching that of the fiber array, as shown in FIG. 7d. An advantage of this approach is that no beam steering due to the angled facet occurs in the beam expander. This grating may advantageously be used to self align the lenses to the fibers in at least one dimension.

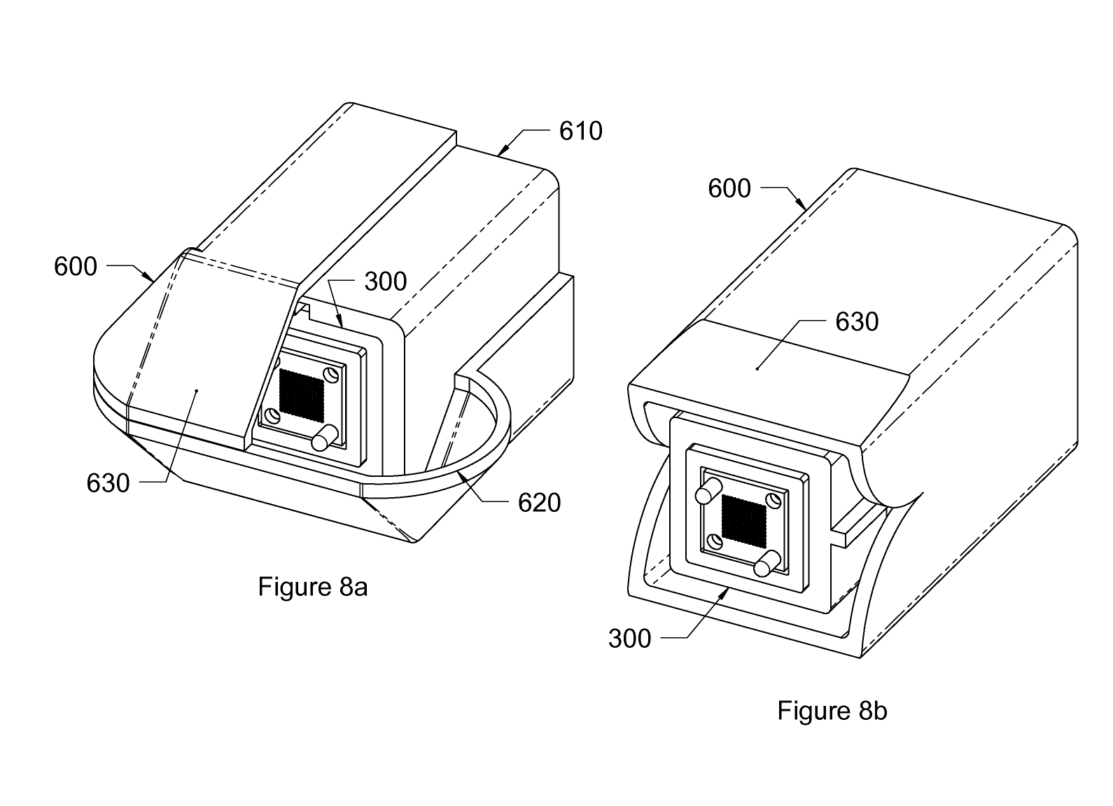

For good quality optical connections it is extremely important that the fiber facets are kept free of dust, debris and contamination. The present invention provides a means for keeping the connector clean by sealing the connector head within an enclosure while disconnected. FIG. 8 illustrates an integrated, clam shell style dust cap 600 suitable for all types of connectors. FIG. 8a is a cutaway view of the closed dust cap enclosing a ferrule 300 surrounded by a connector housing 610 surrounded by a dust cap 600, which is made of flexible material. The shape of the dust cap is such that, when the sides of the mouth 620 are pressed flat against the housing, the mouth 630 opens, as demonstrated in FIG. 8b. Subsequently the ferrule can slide forward within the housing such that it protrudes from the open end of the dust cap as the ferrule is pushed from behind. The ferrule then engages an opposing ferrule to establish the optical connections. The mouth of the dust cap may be actuated by an appropriately designed adapter (not shown), or simply by the forward motion of the ferrule. In either case, the reverse sequence occurs when the connectors are disengaged and the clam shell re-closes.

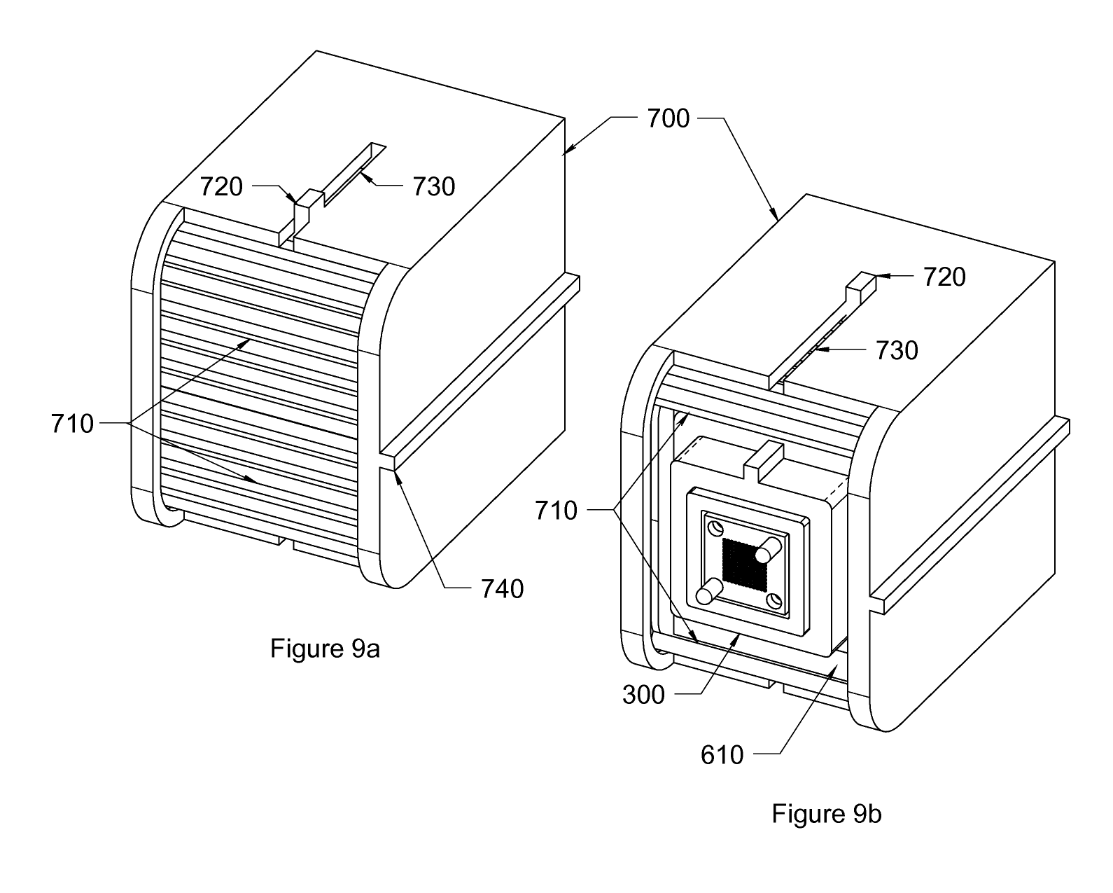

An alternate embodiment, given in FIG. 9, is an integrated, garage door style dust cap 700. In this embodiment, the connector head is sealed behind sliding doors 710 made of flexible material, as illustrated in FIG. 9a. The doors are opened and closed by means of attached handles (top and bottom) 720 and slots 730. A rib 740 is used as an orientation key for the adapter. The handles are actuated by the connector adapter (not shown) and forced backwards as the connector is inserted, thereby opening the doors as shown in FIG. 9b. Subsequently the ferrule 300 can slide forward within the housing 610 such that it protrudes from the open end of the dust cap as it is pushed from behind. The ferrule then engages an opposing ferrule to establish the optical connections. As before, the reverse sequence occurs when the connectors are disengaged and the sliding doors re-close. Alternatively, other door styles may be used, such as non-articulated swing-away or pop-forward doors. The design trade-offs to be made are connector/dust-cap size, manufacturing and operational complexity, insertion depth and reliability.

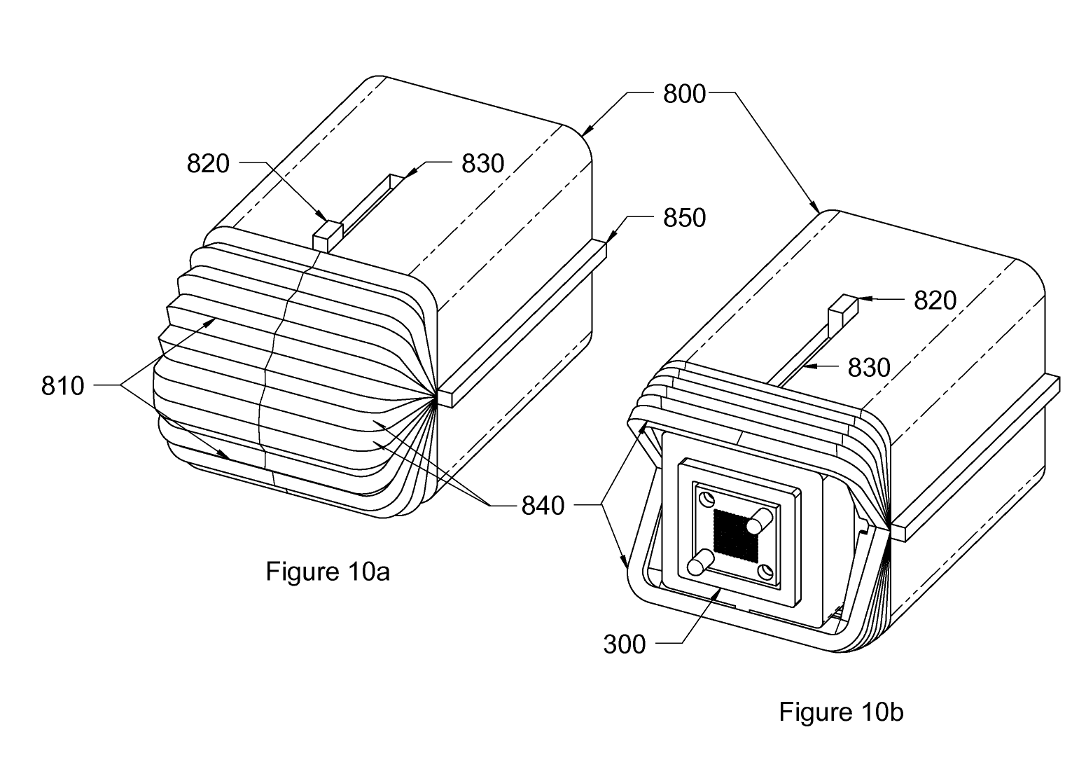

An alternate embodiment, given in FIG. 10, is an integrated, awning style dust cap 800. In this embodiment, the connector head is sealed behind awning type lids 810 made of flexible material, as illustrated in FIG. 10a. The doors are opened and closed by means of handles (top and bottom) 820 and slots 830. The handles pull a wire (not shown) attached to the lip 840 of each lid, thereby folding up the lids in an accordion fashion, as shown in FIG. 10b. A rib 850 is used as an orientation key for the adapter. The handles are actuated by the connector adapter (not shown) and forced backwards as the connector is inserted. Subsequently the ferrule 300 can slide forward within the housing (not visible) such that it protrudes from the open end of the dust cap as it is pushed from behind. The ferrule then engages an opposing ferrule to establish the optical connections. As before, the reverse sequence occurs when the connectors are disengaged and the lids re-close.

The previous description of the disclosed embodiments is provided to enable any person skilled in the art to make or use the present invention. Various modifications to these embodiments will be readily apparent to those skilled in the art, and the generic principles defined herein can be applied to other embodiments without departing from the spirit or scope of the invention. For example, the flexible fingers 170 of the fiber hole may vary in number and/or shape. Also, a wide variety of materials may be chosen for the various components of the embodiments. Lastly, opening actuation of the dust cap can be of any reversible motion, such as that of a camera shutter. It is therefore desired that the present embodiments be considered in all respects as illustrative and not restrictive, reference being made to the appended claims as well as the foregoing descriptions to indicate the scope of the invention.

I claim:

1. A template comprising
a substrate,
a plurality of holes formed in said substrate,
a plurality of flexible fingers formed in at least one end of said plurality of holes,
a plurality of fibers inserted into said plurality of holes such that the fiber tips are coplanar, parallel to said template, and the fiber-to-fiber registration is highly accurate.

2. A multi-fiber optical connector comprising
the template of claim 1 and
a ferrule housing surrounding said template providing for mechanical robustness and optical alignment.

3. The connector of claim 2 further comprising
a beam expander and lens array disposed on and adhered to said plurality of fibers.

4. The connector of claim 3 wherein optical alignment between template and lens array is by means of one or more fiber stubs or guide pins and matching holes.

5. The connector of claim 3 wherein optical alignment between fibers and lens array is by means of self-aligning features, such as angled facets or blind vias, formed on the back side of the lens array.

6. The connector of claim 2 further comprising
a holder surrounding the template, said holder being surrounded by the ferrule housing, allowing either no movement or slight relative movement between said holder and the ferrule housing.

7. The connector of claim 6 wherein mechanical alignment or alignment and joining between template, holder and ferrule is by means of one or more guide pins and guide pin holes.

8. The connector of claim 6 wherein mechanical alignment or alignment and joining between template and holder is by means of recessed edges, corners, protrusions or other datum.

9. A multi-fiber optical connector including an integrated dust cap.

10. The connector of claim 9 wherein the integrated dust cap is of the clam shell, garage door or awning variety.
